(19) United States
(12) Patent Application Publication
(10) Pub. No.: US 2015/0049599 A1
(43) Pub. Date: Feb. 19, 2015

(54) GUARANTEEING MOBILE USER EQUIPMENT REATTACHMENT TO A MINI BASE STATION UNDER INTERMITTENT IP NETWORK FAILURES

(71) Applicant: ARGELA YAZILIM VE BILISIM TEKNOLOJILERI SAN. VE TIC. A.S., Istanbul (TR)

(72) Inventors: FEVZI DURGAN, ISTANBUL (TR); MUSTAFA ERGEN, ISTANBUL (TR); NAZLI GUNEY, ISTANBUL (TR); MELIH AHMET KARAMAN, ISTANBUL (TR); SINGARASELVAN SINGARAVELAN, SUNNYVALE, CA (US)

(73) Assignee: ARGELA YAZILIM VE BILISIM TEKNOLOJILERI SAN. VE TIC. A.S., Istanbul (TR)

(21) Appl. No.: 13/969,298

(22) Filed: Aug. 16, 2013

(51) Int. Cl. H04W 24/04; H04W 60/04

(52) U.S. Cl. CPC H04W 24/04; H04W 60/04
USPC 370/216

(57) ABSTRACT

This invention relates to remedying a major shortcoming of the 3G and beyond cellular wireless communications network architecture, where an intermittent IP network failure causes mobile (cellular) user stations attached to a mini base station (MBS) to become unreachable after the failure is cleared. The MBS automatically changes its configuration and particularly its Location Area Code (LAC) value from its previous LAC (i.e., before the occurrence of the failure), according to an aspect of this invention, to force the mobile user equipment (MUE) to re-register with the cellular wireless communications network after the IP network failure is cleared. Doing so, the MUE becomes reachable without needing any manual power cycling of the MBS or the MUE.

### BACKGROUND OF THE INVENTION

1. Field of Invention

The disclosed invention generally relates to the field of base stations of 3G and beyond cellular wireless communications networks. In particular, it relates to mini base stations also known as femtocells or femtocell access points (FAPs) that are conveniently used in a home or office to provide cellular service. More specifically, the invention relates to a mini base station that is attached to the cellular network and IP network simultaneously and can configure itself when network conditions change.

2. Discussion of Related Art

Each mini base station in a 3G network is assigned a specific and planned range of Location Area Codes (LACs) during provisioning by the Home Node B Management System (HNB-MS or simply HMS). A LAC is basically a fixed length code identifying a location area within a Public Land Mobile Network. Part of the location area identification can be coded using a full hex representation except two reserved hex numbers (0000 and FFFE). The distribution of LACs to base stations is a core network planning task. The LAC's length is 16 bits. Therefore, there are 65, 216 LAC values as defined in the Technical Specification 3GPP TS 23.003 entitled, “Numbering, addressing and identification”. A typical conventional network though might use less than 1000 of these. A list of LACs reserved for use by mini base stations (MBSs) may range from 100 to 10,000.

One of the LACs from the assigned LAC range is randomly chosen by the mini base station as its LAC. The main use of a LAC in a mini base station is locating mobile devices in a network. A mobile user-equipment (MUE) obtains the LAC of the base station it camps onto and performs a location update procedure as known in prior art. In fact, each MUE periodically performs location update procedures to inform the core network of its current location. Also, the MUE periodically sniffs the broadcast radio channel (BCH) emanating from base stations in the neighborhood to detect any changes in the relative power levels received from different base stations, in which case it initiates a location update procedure towards the base station with the best link as defined in Technical Specification 3GPP TS 24.008 entitled, “Mobile radio interface Layer 3 specification; Core Network protocols; Stage 3”.

The main goal of the random assignment of LACs in a 3G network is decreasing the LAC collisions. Macro base stations are assigned different ranges of LACs regionally. However, same or overlapping sub-LAC ranges from within that range assigned to macro base stations may need to be selected in extending coverages of mobile networks, such as those LAC ranges assigned to MBSs simply because there may not be enough LACs to uniquely number all MBSs under a macro base station. When two MBSs or a macro base station and a MBS have the same LAC, a collision will happen. Furthermore, if two MBSs have the same LAC values by coincidence, a MUE (which is allowed to attach to one of these two MBSs), will not be able to camp onto the other MBS, which has the same LAC value, although it is authorized to do so. Preventing LAC collisions is an essential feature for overcoming potential camping problems of MUEs.

The basic LAC selection algorithm is to choose the first available LAC from the given list of LACs assigned to a MBS at the time of provisioning.

Each time a MUE tries to camp onto a MBS to which it is not authorized to connect, the MUE is rejected by the MBS with a cause such as “#15 No Suitable Cells In This Location Area”. Upon receiving this message, the LAC of that unauthorized MBS is stored in the MUE's SIM card as “forbidden location areas for roaming” or simply ‘forbidden LAC’. The forbidden LACs collected this way (i.e., by attachment attempts to various unauthorized MBSs) form the ‘forbidden LAC list’, which is not deleted unless the MUE is powered off or its SIM card is removed. A MUE won't try to camp onto its authorized MBS, if the authorized MBS uses a LAC which has already been entered in the forbidden LAC list in the MUE as a result of a previous attempt to another (unauthorized) MBS with the same LAC value (by coincidence). In order to decrease such occurrences of LAC collisions, which obviously have an undesirable effect, MBSs select the LAC randomly from available LAC list using the LAC randomization feature. LAC randomization is activated in prior art only when the MBS is powered up or rebooted manually or after an electric outage. As described in the patent application of US 2010/0227645A1 by Keevill et al., a MBS sniffs the cellular network for LACs that are in-use by other base stations to select a different LAC at the time of power up or reboot. This patent application also describes the process by which unauthorized MUE is rejected to camp on a MBS. However, the LAC value remains static unless there is a major change in the cellular network according to this patent application (para [0062]), which is an aspect of their implementation this invention remedies.

Embodiments of the present invention are an improvement over prior art systems and methods.

### SUMMARY OF THE INVENTION

Embodiments of the present invention is a significant improvement over prior art methods of an MBS by activating the LAC selection function by the MBS immediately after an intermittent IP network failure is detected just to force it to select a different LAC than the LAC it had before the intermittent IP network failure. Doing so, the LAC of the MBS is modified, and consequently, the location update of the MUE is forced. Please note that according to prior art, when an IP network failure happens, the MBS and in turn the MUE becomes unreachable through the mobile core network because the context of all MUE attached to that MBS, which becomes unreachable during the failure, are automatically cleared from the HNB GW. According to prior art, even after the failure is cleared, the MUE will not perform a location update to signal the network its current location and to re-establish its MUE context within the HNB GW, because the LAC of its MBS is unchanged after failure. The MUE becomes reachable only after it is manually powered off or the MBS is manually powered off and rebooted. This creates a major problem because intermittent IP failures are frequent. The method of this invention remedies the aforementioned problem.

In one embodiment, the present invention provides a method, as implemented in a mini base station, to detect an intermittent IP network failure and reassign its Location Area Code (LAC) from a list of available LACs, wherein the method comprises: powering down a radio downlink and removing all associated context of existing mobile user equipment from memory; sniffing a broadcast channel (BCH) of at least one neighboring base station to obtain in-use base station LACs; selecting a new LAC from said list of available LACs; registering said new LAC with a Home Node B (HNB) gateway associated with said mini base station after recovering from said intermittent IP network failure; powering up said radio downlink and forcing mobile user equipment to obtain said new LAC and reregister through a Location Area Update procedure and recreating context IDs associated with mobile user equipment which successfully completed said Location Area Update Procedure, and wherein said HNB gateway also recreating said context IDs associated with said mobile user equipment.

In one embodiment, the present invention provides a mini base station to detect an intermittent IP network failure and reassign its Location Area Code (LAC) from a list of available LACs, wherein the mini base station comprises: one or more processors; and a memory comprising instructions which, when executed by the one or more processors, cause the one or more processors to detect an intermittent IP network failure and reassign its Location Area Code (LAC) from a list of available LACs by: powering down a radio downlink and removing all associated context of existing mobile user equipment from memory; sniffing a broadcast channel (BCH) of at least one neighboring base station to obtain in-use base station LACs; selecting a new LAC from said list of available LACs; registering said new LAC with a Home Node B (HNB) gateway associated with said mini base station after recovering from said intermittent IP network failure; powering up said radio downlink and forcing mobile user equipment to obtain said new LAC and reregister through a Location Area Update procedure and recreating context IDs associated with mobile user equipment which successfully completed said Location Area Update Procedure, and wherein said HNB gateway also recreating said context IDs associated with said mobile user equipment.

In one embodiment, the present invention provides non-transitory, computer accessible memory medium storing program instructions for detecting an intermittent IP network failure at a mini base station and reassign its Location Area Code (LAC) from a list of available LACs, wherein the program instructions are executable by a processor to: power down a radio downlink and remove all associated context of existing mobile user equipment from memory, sniff a broadcast channel (BCH) of at least one neighboring base station to obtain in-use base station LACs; select a new LAC from said list of available LACs; register said new LAC with a Home Node B (HNB) gateway associated with said mini base station after recovering from said intermittent IP network failure; power up said radio downlink and force mobile user equipment to obtain said new LAC and reregister through a Location Area Update procedure and recreate context IDs associated with mobile user equipment which successfully completed said Location Area Update Procedure, and wherein said HNB gateway also recreates said context IDs associated with said mobile user equipment.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 illustrates a method according to one embodiment of the present invention.

FIG. 2 illustrates a mini base station attached to an IP network and a 3G mobile network.

FIG. 3 illustrates a mini base station with the components used in the method of this invention.

FIG. 4A illustrates a flowchart outlining the steps of the LAC selection during an intermittent IP failure according to this invention.

FIG. 4B illustrates a flowchart outlining the steps of re-registration of a mobile user equipment with the mini base station after intermittent IP network failure is cleared.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

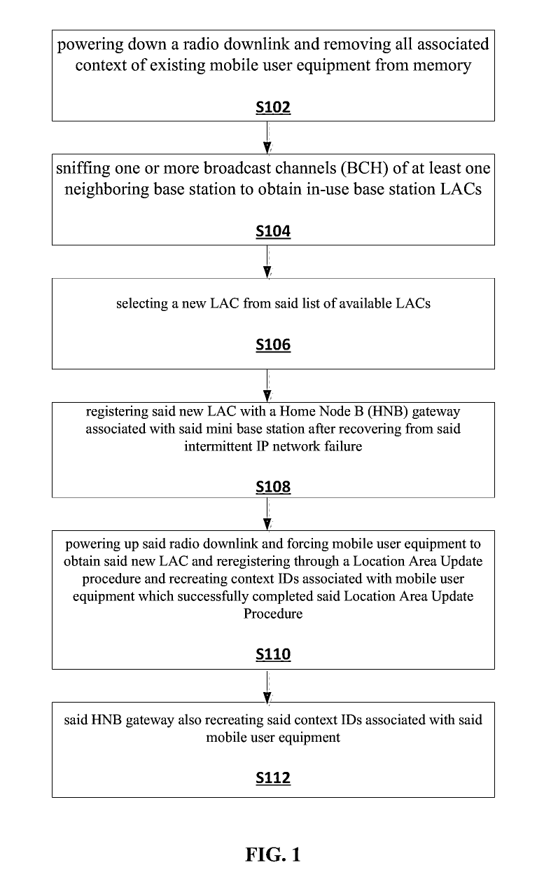

FIG. 1 illustrates an embodiment of the present invention's method, as implemented in a mini base station, for detecting an intermittent IP network failure and reassigning its Location Area Code (LAC) from a list of available LACs, wherein the method comprises: powering down a radio downlink towards all the mobile user equipment it provides service to and removing all associated context of existing mobile user equipment from memory (S102); sniffing a broadcast channel (BCH) of at least one neighboring base station to obtain in-use base station LACs (S104); selecting a new LAC from the list of available LACs (S106); registering the new LAC with a Home Node B (HNB) gateway associated with the mini base station after recovering from the intermittent IP network failure (S108); powering up the radio downlink towards all mobile user equipment forcing mobile user equipment to obtain the new LAC and reregister through a Location Area Update procedure and recreating context IDs associated with mobile user equipment which successfully completed the Location Area Update Procedure (S110), and wherein the HNB gateway also recreating the context IDs associated with the mobile user equipment (S112). In one embodiment, the present invention provides a mini base station that implements the method of FIG. 1.

In one embodiment, the list of available LACs comprises LACs remaining after removing the in-use LACs and LAC used by the mini base station before the intermittent IP network failure.

In one embodiment, when said list of available LACs is null, said mini-base station chooses one of said in-use base station LACs discarding the last one in use by the said mini base station. In one embodiment, the chosen in-use base station LAC is a first available LAC in an available LAC list. In another embodiment, the chosen in-use base station LAC is randomly selected from an available LAC list.

Described below are the LAC selection components in more detail after, first, giving an overview of the problem associated with intermittent IP failure.

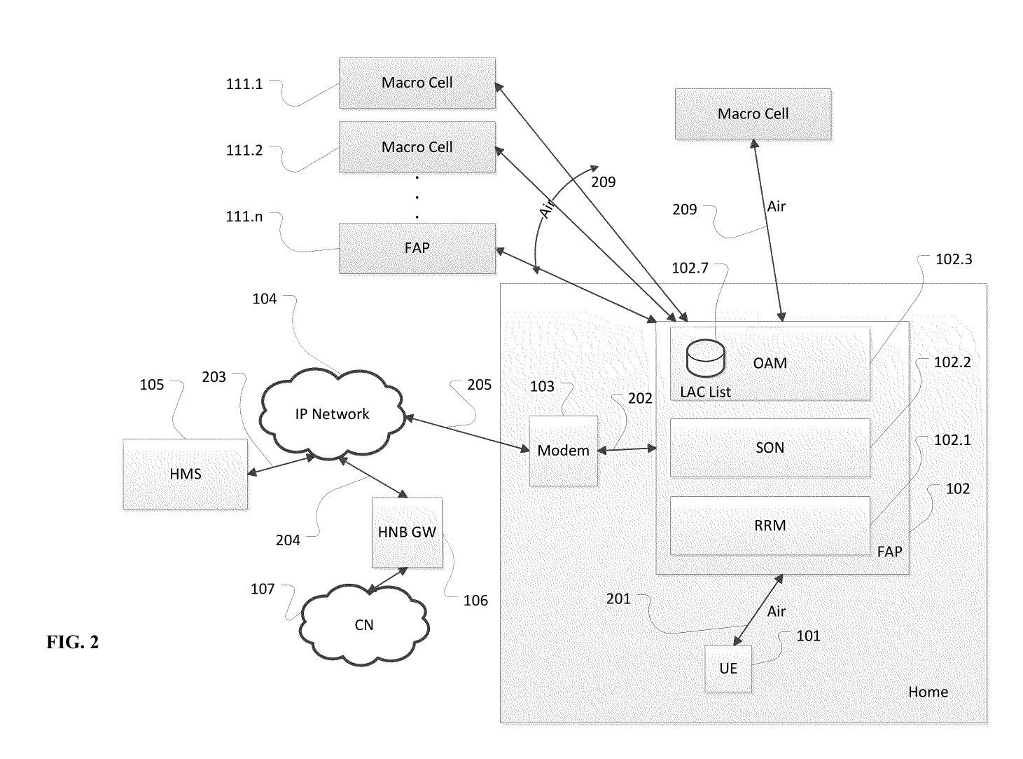

FIG. 2 is an illustration of a mini base station (MBS) (also referred to as Femtocell Access Point (FAP) in the figures) attached to an IP network and mobile user equipment (MUE). Shown in the figure is a MUE 101, which is attached to MBS 102 with a radio link 201. MBS 102 monitors macro base stations and other MBSs, 111.1 through 111.n, through over the air broadcast channel (BCH) 209.

MBS 102 is also attached to the 3G network through an IP connection 202 which attaches to an ADSL modem 103. IP network 104 connects Home NB Management System (HMS) 105 and HNB Gateway 106 with MBS 102 through modem 103. 3G Core Network (CN) 107 is also reachable through HNB GW 106. Note that all links 202, 203, 204 and 205 are IP connections and possible points of IP failure.

An intermittent IP failure is defined as MBS's failure to reach Mobile CN 107, which includes failures of
ADSL modem 103,
IP links 202, 204 and 205,
IP network 104, and/or
HNB GW 106.
   Under such failures, MUE 101 becomes unreachable through the mobile network.

MBS 102 has three key functionalities as it pertains to this invention:
102.1 is the Radio Resource Management (RRM) function, which mainly manages the radio connections to MUE 101.
102.2 is the Self Organizing Networks (SON) function, which is responsible for sniffing the broadcast channels (BCHs) and selecting a new LAC using LAC randomization capability.
102.3 is the Operations Administration and Management (OAM) function which is responsible for MBS provisioning and configuration. The LAC list 102.7 sits typically within the OAM function.

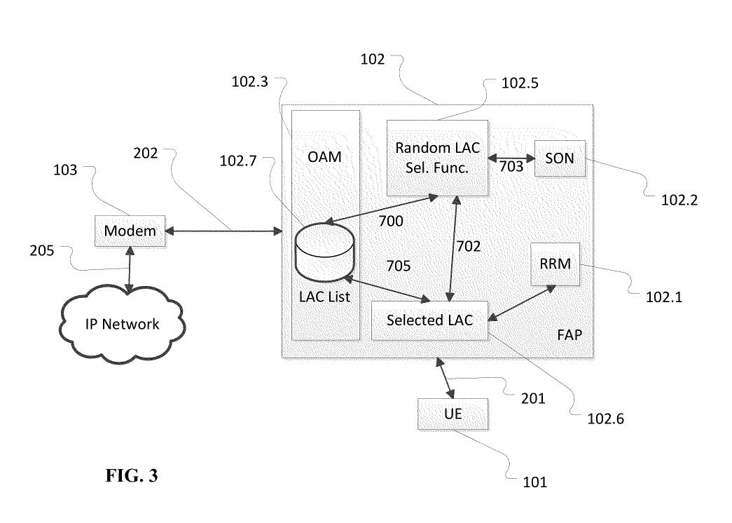

FIG. 3 depicts the LAC Selection Components in more detail. The Random LAC Selection Function 102.5 is within or in association with SON. That association is shown by link 703. The LAC list 102.7 sits within the OAM 102.3 and is provided at the time of provisioning by HMS 105. Random LAC Selection Function 102.5 uses LAC list 102.7 using association 700. The Selected LAC 102.6 represents the current value of LAC selected from LAC list 102.7 through running Random LAC Selection Function 102.5, and hence link 705 shows the association with LAC list and link 702 shows the association with Random LAC Selection Function 102.5.

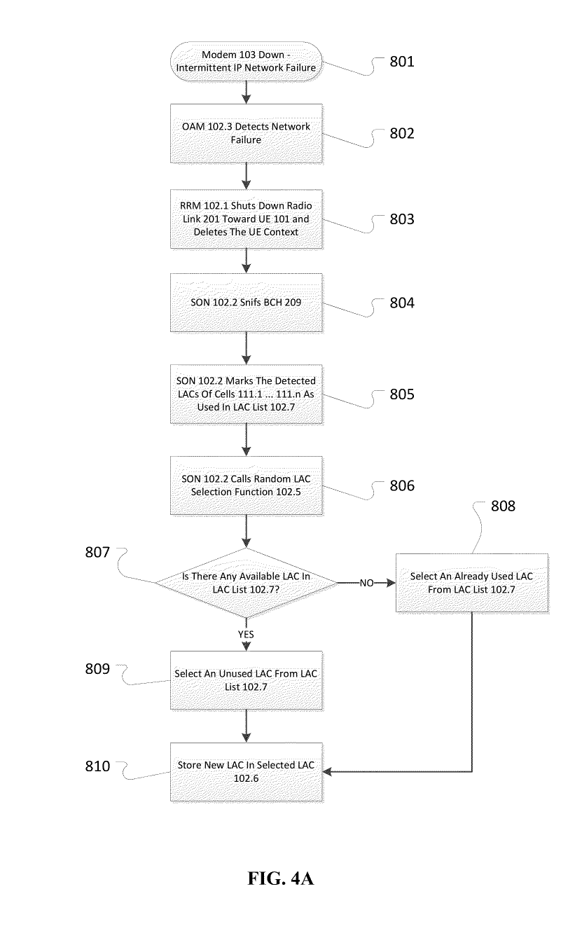

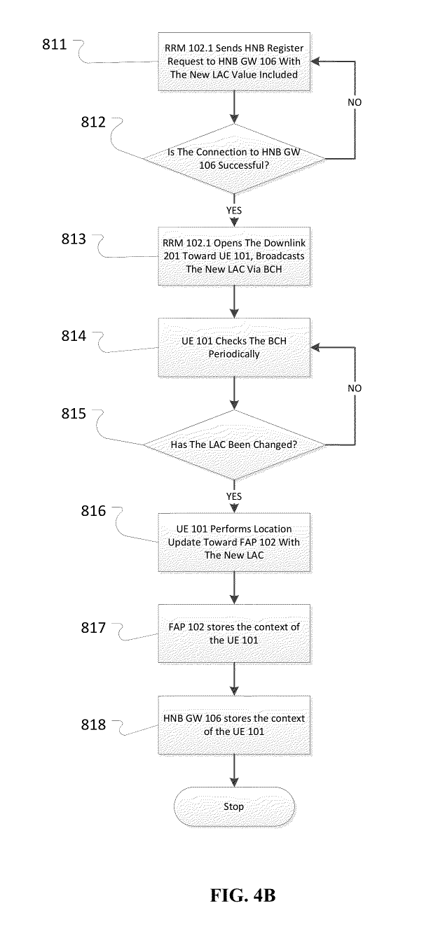

FIG. 4A shows the method or present invention starting at step 801 when an intermittent IP failure happens (i.e., Modem 103 is down). In step 802, OAM 102.3 detects the loss of the IP connection. Thereafter, in step 803, RRM 102.1 shuts down the radio link 201 towards MUE 101 and automatically deletes the MUE context from its database (i.e., removes any information pertaining to MUE 101 since the air connection is closed).

SON 102.2 starts sniffing BCH 209 in step 804, according to an aspect of this invention. By sniffing these links, SON 102.2 collects the LACs currently being used by the neighbor macro base stations and MBSs, and constructs a set of ‘LACs in use’. Note that the LAC used by the MBS prior to the network failure is also included in the ‘LACs in use’ in step 805.

SON 102.2 calls Random LAC Selection Function 102.5 in step 806 to trigger the new LAC selection process. In step 807, SON 102.2 checks to determine if there is a set of ‘unused LACs’ in the LAC list, where

(set of unused LACs)=(set of LACs in the LAC List)−(set of LACs in use)
If the set of unused LACs is null (meaning there are no LACs available in the LAC list that are not being used), then in step 808, the MBS selects one of the LACs in use (other than its previous LAC).
If there are LACs in the set of unused LACs, then in step 809, it selects one of the unused LACs. The selection can be performed randomly, or simply by selecting the first LAC in the list, or any other reasonable method.
   In step 810, the new LAC is stored in ‘Selected LAC 102.6’. The steps described above are the new methods per this invention.

FIG. 4B shows the steps following the new LAC selection per FIG. 3a, right after the failure is cleared. In step 811, RRM 102.1 sends a register request to HNB GW 106 with the newly selected LAC value. Step 812 checks to determine if the connection to HNB GW is successful. If it fails, then step 811 is repeated until the connection is established.

If the connection is successful, and the register request succeeds, in step 813, MBS opens up air link 201 towards MUE 101, and starts broadcasting its new LAC via broadcast channel BCH 209. Since MUE periodically checks BCH 209 in step 814, it checks to determine if the LAC of MBS has changed in step 815. If the MBS has changed its LAC, in step 816, MUE 101 performs a location update towards MBS 102 with the new LAC. If the location update is successful, in step 817 MBS 102 stores the MUE context and in step 818 HNB GW 106 stores the MUE context of MUE 101. After these steps, the MUE 101 becomes reachable through the mobile CN.

Embodiments of the present invention is a significant improvement over prior art methods of an MBS by activating the LAC selection function by the MBS immediately after an intermittent IP network failure is detected just to force it to select a different LAC than the LAC it had before the intermittent IP network failure. Doing so, the LAC of the MBS is modified, and consequently, the location update of the MUE is forced. Please note that according to prior art, when an IP network failure happens, the MBS and in turn the MUE becomes unreachable through the mobile core network because the context of all MUE attached to that MBS, which becomes unreachable during the failure, are automatically cleared from the HNB GW. According to prior art, even after the failure is cleared, the MUE will not perform a location update to signal the network its current location and to re-establish its MUE context within the HNB GW, because the LAC of its MBS is unchanged after failure. The MUE becomes reachable only after it is manually powered off or the MBS is manually powered off and rebooted. This creates a major problem because intermittent IP failures are frequent. The method of this invention remedies the aforementioned problem.

Logical operations can be implemented as modules configured to control a processor to perform particular functions according to the programming of the module. These modules may be stored on the storage device and loaded into memory at runtime or may be stored as would be known in the art in other computer-readable memory locations. For examples, the modules may store instructions for detecting an intermittent IP network failure at a mini base station and reassign its Location Area Code (LAC) from a list of available LACs, wherein a plurality of modules may, for example, be modules controlling a processor to perform the following steps: power down a radio downlink and remove all associated context of existing mobile user equipment from memory, sniff a broadcast channel (BCH) of at least one neighboring base station to obtain in-use base station LACs; select a new LAC from said list of available LACs; register said new LAC with a Home Node B (HNB) gateway associated with said mini base station after recovering from said intermittent IP network failure; power up said radio downlink and forcing mobile user equipment to obtain said new LAC and reregister through a Location Area Update procedure and recreate context IDs associated with mobile user equipment which successfully completed said Location Area Update Procedure, and wherein said HNB gateway also recreates said context IDs associated with said mobile user equipment.

In one embodiment, the list of available LACs comprises LACs remaining after removing the in-use LACs and LAC used by the mini base station before an intermittent IP network failure, where the selected new LAC is a first LAC in an available LAC list or the selected new LAC is randomly selected from an available LAC list.

In another embodiment, when the list of available LACs is null, the mini-base station chooses one of the in-use base station LACs different than its LAC before the occurrence of an intermittent IP network failure. The selected new LAC may either be a first LAC in the set of base station LACs in-use excluding the LAC used before the occurrence of said intermittent IP network failure, or is randomly chosen from the set of base station LACs in-use excluding the LAC used before the occurrence of said intermittent IP network failure.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable BluRay® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As noted above, particular embodiments of the subject matter have been described, but other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

### CONCLUSION

A system and method has been shown in the above embodiments for guaranteeing mobile user equipment reattachment to a mini base station under intermittent IP network failures. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A method, as implemented in a mini base station, to detect an intermittent IP network failure and reassign its Location Area Code (LAC) from a list of available LACs comprising:
a. powering down a radio downlink and removing all associated context of existing mobile user equipment from its memory;
b. sniffing a broadcast channel (BCH) of at least one neighboring base station to obtain in-use base station LACs;
c. selecting a new LAC from said list of available LACs;
d. registering said new LAC with a Home Node B (HNB) gateway associated with said mini base station after recovering from said intermittent IP network failure;
e. powering up said radio downlink and forcing mobile user equipment to obtain said new LAC and reregister through a Location Area Update procedure, and recreating context IDs associated with mobile user equipment which successfully completed said Location Area Update Procedure, and
wherein said HNB gateway also recreating said context IDs associated with said mobile user equipment.

2. The method of claim 1, wherein said list of available LACs comprises LACs remaining after removing said in-use LACs and LAC used by said mini base station before said intermittent IP network failure.

3. The method of claim 2, wherein said selected new LAC is a first LAC in an available LAC list comprising at least one available LAC.

4. The method of claim 2, wherein said selected new LAC is randomly chosen from an available LAC list comprising at least one available LAC.

5. The method of claim 2, wherein when said list of available LACs is null, said mini-base station choosing one of said in-use base station LACs different than its LAC before the occurrence of said intermittent IP network failure.

6. The method of claim 5, wherein said selected new LAC is a first LAC in the set of base station LACs in-use excluding the LAC used before the occurrence of said intermittent IP network failure.

7. The method of claim 5, wherein said selected new LAC is randomly chosen from the set of base station LACs in-use excluding the LAC used before the occurrence of said intermittent IP network failure.

8. A mini base station for detecting an intermittent IP network failure and reassigning its Location Area Code (LAC) from a list of available LACs comprising:
one or more processors; and
a memory comprising instructions which, when executed by the one or more processors, cause the one or more processors to detect an intermittent IP network failure and reassign its Location Area Code (LAC) from a list of available LACs by:
a. powering down a radio downlink and removing all associated context of existing mobile user equipment from memory;
b. sniffing a broadcast channel (BCH) of at least one neighboring base station to obtain in-use base station LACs;
c. selecting a new LAC from said list of available LACs;
d. registering said new LAC with a Home Node B (HNB) gateway associated with said mini base station after recovering from said intermittent IP network failure;
e. powering up said radio downlink and forcing mobile user equipment to obtain said new LAC and reregister through a Location Area Update procedure and recreating context IDs associated with mobile user equipment which successfully completed said Location Area Update Procedure, and
wherein said HNB gateway also recreating said context IDs associated with said mobile user equipment.

9. The mini-base station of claim 8, wherein said list of available LACs comprises LACs remaining after removing said in-use LACs and LAC used by said mini base station before said intermittent IP network failure.

10. The mini-base station of claim 9, wherein said selected new LAC is a first LAC in an available LAC list comprising at least one available LAC.

11. The mini-base station of claim 9, wherein said selected new LAC is randomly chosen from an available LAC list comprising at least one available LAC.

12. The mini-base station of claim 9, wherein when said list of available LACs is null, said mini-base station choosing one of said in-use base station LACs different than its LAC before the occurrence of said intermittent IP network failure.

13. The mini-base station of claim 12, wherein said selected new LAC is a first LAC in the set of base station LACs in-use excluding the LAC used before the occurrence of said intermittent IP network failure.

14. The mini-base station of claim 12, wherein said selected new LAC is randomly chosen from the set of base station LACs in-use excluding the LAC used before the occurrence of said intermittent IP network failure.

15. A non-transitory, computer accessible memory medium storing program instructions for detecting an intermittent IP network failure at a mini base station and reassign its Location Area Code (LAC) from a list of available LACs, wherein the program instructions are executable by a processor to:
a. power down a radio downlink and remove all associated context of existing mobile user equipment from memory;
b. sniff a broadcast channel (BCH) of at least one neighboring base station to obtain in-use base station LACs;
c. select a new LAC from said list of available LACs;
d. register said new LAC with a Home Node B (HNB) gateway associated with said mini base station after recovering from said intermittent IP network failure;
e. power up said radio downlink and forcing mobile user equipment to obtain said new LAC and reregister through a Location Area Update procedure and recreating context IDs associated with mobile user equipment which successfully completed said Location Area Update Procedure, and
wherein said HNB gateway also recreating said context IDs associated with said mobile user equipment.

16. The mini-base station of claim 15, wherein said list of available LACs comprises LACs remaining after removing said in-use LACs and LAC used by said mini base station before said intermittent IP network failure.

17. The mini-base station of claim 16, wherein said selected new LAC is a first LAC in an available LAC list comprising at least one available LAC.

18. The mini-base station of claim 16, wherein said selected new LAC is randomly chosen from an available LAC list comprising at least one available LAC.

19. The mini-base station of claim 15, wherein when said list of available LACs is null, said mini-base station choosing one of said in-use base station LACs different than its LAC before the occurrence of said intermittent IP network failure.

20. The mini-base station of claim 19, wherein said selected new LAC is a first LAC in the set of base station LACs in-use excluding the LAC used before the occurrence of said intermittent IP network failure.

21. The mini-base station of claim 19, wherein said selected new LAC is randomly chosen from the set of base station LACs in-use excluding the LAC used before the occurrence of said intermittent IP network failure.
